(19) United States
(12) Patent Application Publication
(10) Pub. No.: US 2019/0037876 A1
(43) Pub. Date: Feb. 7, 2019

(54) NON-HYDROGENATED CHOCOLATE WITH COCOA BUTTER ALTERNATIVE AND PREPARATION METHOD THEREFOR

(71) Applicant: SHANGHAI HI-ROAD FOOD TECHNOLOGY CO., LTD., Shanghai (CN)

(72) Inventor: Haihu HUANG, Shanghai (CN)

(73) Assignee: SHANGHAI HI-ROAD FOOD TECHNOLOGY CO., LTD., Shanghai (CN)

(21) Appl. No.: 16/075,662

(22) PCT Filed: Nov. 28, 2016
(86) PCT No.: PCT/CN2016/107570

§ 371 Date: Aug. 5, 2018

(30) Foreign Application Priority Data
Mar. 27, 2016 (CN) 201610179624.3

(51) Int. Cl. A23G 1/38; A23G 1/40; A23G 1/46; A23G 1/44; A23G 1/48; A23G 1/00

(52) U.S. Cl. CPC A23G 1/38; A23G 1/40; A23G 1/46; A23V 2002/00; A23G 1/48; A23G 1/0009; A23G 1/44

(57) ABSTRACT

The present invention discloses a non-hydrogenated cocoa butter replacer chocolate and manufacturing method thereof consisting of the following percentages of raw materials: a non-hydrogenated vegetable oil: 35-50%; a white sugar: 30-50%; a cocoa powder: 6-30%; a milk powder: 5%-40%; a maltodextrin: 1-10%; a soybean protein: 2-8%; a glyceryl monostearate: 1-5%; a soybean phospholipid: 0.2-0.5%; a polyglycerol polyricinoleate: 0.1-0.3%; a sucrose fatty acid ester: 0.1-0.3%; a food flavor: 0.01-0.1%. Compared with the prior art, the present invention has the following advantages: (1) The non-hydrogenated cocoa butter replacer chocolate of the invention does not contain hydrogenated vegetable oil and does not contain trans-fatty acids and can meet people's requirements in health and nutritious foods in today's society. (2) When non-hydrogenated vegetable oil is used as a raw material to prepare cocoa butter replacer chocolate in the present invention, the synergistic effect of the emulsifier overcomes the disadvantages of non-hydrogenated vegetable oils in the process of chocolate production being a soft texture, the process being not easy to operate and the product having a bad taste, and it meets the requirements on quality by the customers.

### TECHNICAL FIELD

The present invention relates to chocolate and manufacturing method thereof, in particular, to a non-hydrogenated cocoa butter replacer chocolate and manufacturing method thereof.

### BACKGROUND

In the production of domestic traditional cocoa butter replacer (CBR) chocolate, hydrogenated vegetable oil is the main raw material. Hydrogenated vegetable oils are artificial oils, including well-known creamers, non-dairy creamers, margarine, and cocoa butter replacer. It is produced by catalytic hydrogenation of common vegetable oils under certain temperature and pressure. The hydrogenated vegetable oil is homogeneous, has no odor, has increased hardness, and has a high melting point; therefore, it can maintain its solid shape at room temperature. The plasticity, fusion, and emulsification properties thereof are all enhanced, and the food can be made crisper. At the same time, it can also extend the shelf lives of products; therefore, it is widely used in food processing. However, the chemical structures of some hydrogenated vegetable oils that have not been fully hydrogenated contain trans-linked bonds to form trans-fatty acids, which do not have the nutritional value of pure natural vegetable oils and are harmful to human health. In addition to producing some trans fatty acids, some metal catalysts may remain in the process of hydrogenated oil processing. These substances have an impact on human health, which severely limits the safety of their uses in food processing.

In today's society, people have a higher pursuit of quality of life and are increasingly concerned about food safety. Health and safety have become primary criteria for consumers to purchase products. Therefore, it is necessary to use non-hydrogenated vegetable oils instead of hydrogenated vegetable oils in food processing. Non-hydrogenated fats are fats extracted from natural plants without hydrogenation. Because they have not been hydrogenated, they do not contain trans-fatty acids and are beneficial to human health. Compared to hydrogenated vegetable oils, non-hydrogenated vegetable oils contain more than 16% of unsaturated fatty acids that are beneficial to humans. From a nutritional point of view, it is nutritionally free of cholesterol and trans-fatty acids and has a high content of unsaturated fatty acids. In addition, because non-hydrogenated vegetable oils can undergo normal metabolism, they have high nutritional value and are beneficial to human health. It has become a general trend for people to pursue healthy foods and is an ideal edible oil. However, when non-hydrogenated fats are used in foods, they have a soft texture, are not easy to handle, and have the disadvantage of poor taste. These properties severely limit their applications in food processing. Therefore, the present invention mainly aims to solve the above-mentioned shortcomings in the uses of non-hydrogenated fats, by using emulsifiers and stabilizers, blending of different tastes of non-hydrogenated fats, and improving the processes, to improve application properties such as emulsification uniformity, stability, handling and mouthfeel, and to prepare a non-hydrogenated cocoa butter replacer chocolate with improved nutritional value and health characteristics of products.

### SUMMARY OF THE INVENTION

The present invention aims at providing a non-hydrogenated cocoa butter replacer chocolate and manufacturing methods thereof, wherein non-hydrogenated vegetable oils are used instead of hydrogenated vegetable oils in raw materials to avoid harm to the human body from saturated fatty acids and trans fatty acids in hydrogenated vegetable oils, and to overcome the disadvantages of non-hydrogenated vegetable oils in the production of chocolate, resulting in products with performance and quality equaling or surpassing those of the products prepared with hydrogenated oils.

To achieve above objectives, the present invention provides a chocolate made from non-hydrogenated cocoa butter replacer consisting of the following percentages by weight of raw materials:

non-hydrogenated vegetable oil: 35-50%;

white sugar: 30-50%;

cocoa powder: 6-30%;

milk powder: 5%-40%;

maltodextrin: 1-10%;

soybean protein: 2-8%;

glyceryl monostearate: 1-5%;

soybean phospholipids: 0.2-0.5%;

polyglycerol polyricinoleate (PGPR): 0.1-0.3%;

sucrose fatty acid ester: 0.1-0.3%;

food flavor: 0.01-0.1%.

The non-hydrogenated vegetable oil is a mixture of refined palm kernel oil and coconut oil having a weight ratio of 25-28:10-12.

The milk powder is skimmed milk powder and whey powder.

Further, the present invention provides a preparation method for non-hydrogenated cocoa butter replacer chocolate. The non-hydrogenated chocolate prepared by the method has good flavor and operability, the method mainly comprising the steps of:

1) pulverizing, using a sugar powder machine, the white sugar into a sugar powder.

2) putting the non-hydrogenated vegetable oil, the sucrose fatty acid ester, the glyceryl monostearate into a melting pot to melt to obtain an oil phase, which is kept at 70-90° C. before use.

3) mixing the sugar powder, the cocoa powder, the milk powder, the soy protein powder, the maltodextrin, and a portion of the oil phase, and transferring the mixture to a two-roll mill and a five-roll mill to grind to 15-30 microns. Then, transporting the milled mixture to a mixing tank with shear agitation function, and adding remaining oil phase. Shearing and stirring the mixture until a uniform chocolate slurry is formed. Finally, adding the soybean phospholipids, the polyglycerol polyricinoleate, and the food flavor.

4) transporting the finely milled material to an insulation tank for chocolate. Then, pouring with a pouring machine or manually pouring into a cooling channel for cooling at 3-10° C. After cooling, performing packaging, inspection, and storage.

In the present invention, the non-hydrogenated vegetable oil is prepared by mixing non-hydrogenated oils of refined palm kernel oil and coconut oil, which solves the problem of a low melting point when using a single non-hydrogenated vegetable oil.

In step 3), during the milling process, the mixture may be milled in three successive steps of tightening grids with a milling time of 8-10 hours and a temperature of 50-75° C. until the chocolate slurry is finely milled to 15-30 microns. The grid of the milling machine is loosened, and then the soybean phospholipid, the polyglycerol polyricinoleate, and the food flavor are added and mixed for half an hour before delivery to the chocolate insulation tank, and filling.

Compared with the prior art, the present invention has the following advantages:

(1) The non-hydrogenated cocoa butter replacer chocolate of the invention does not contain hydrogenated vegetable oil, does not contain trans-fatty acids, and can meet people's requirements for health and nutritious foods in today's society.

(2) When non-hydrogenated vegetable oil is used as a raw material to prepare cocoa butter replacer chocolate in the present invention, the synergistic effect of the emulsifier overcomes the disadvantages of soft texture of non-hydrogenated vegetable oils in the process of chocolate production, being difficult to process, and the product having a bad taste. Products of the invention meet the requirements for quality by the customers.

### DETAILED DESCRIPTION

The technical features of the present invention are further described below in conjunction with specific examples.

### EXAMPLE 1

The recipe for producing 100 kg of non-hydrogenated cocoa butter replacer chocolate is as follows: non-hydrogenated refined palm kernel oil: 28 kg; non-hydrogenated coconut oil: 10 kg; white sugar: 32 kg; cocoa powder: 8 kg; skim milk powder: 10 kg; whey powder: 2.5 kg; maltodextrin: 4.85 kg; soybean protein powder: 1.8 kg; glyceryl monostearate: 2 kg; soy phospholipid: 0.4 kg; a polyglycerol polyricinoleate: 0.2 kg; sucrose fatty acid ester: 0.2 kg; and food flavor vanillin: 0.05 kg.

Preparation Process:

1) pulverizing the white sugar, using a sugar powder machine, into a sugar powder.

2) putting the non-hydrogenated vegetable oil, the sucrose fatty acid ester, and the glyceryl monostearate into a melting pot to melt to obtain an oil phase, which is kept at 70-90° C. for use.

3) mixing the sugar powder, the cocoa powder, the milk powder, the soy protein powder, the maltodextrin, and a portion of the oil phase; and transferring the mixture to a two-roll mill and a five-roll mill to grind to 15-30 microns. Then, transporting the milled mixture to a mixing tank with shear agitation function. Adding the remaining oil phase to the milled mixture, shearing, and stirring the mixture until a uniform chocolate slurry is formed. Finally, adding the soybean phospholipid, the polyglycerol polyricinoleate, and the food flavor.

4) transporting the finely milled material to an insulation tank for chocolate, and then pouring with a pouring machine or manually pouring into a cooling channel for cooling at 3-10° C. After cooling, performing packaging, inspection, and storage.

Finished warehouse temperature should be maintained at 18-25° C. and relative humidity≤60%.

The chocolate obtained by the above method has been tested. Its trans-fatty acid content is 0, its texture is no longer soft, and its operability is good, without vegetable oil taste and having good taste and mouthfeel. This product is compared with a hydrogenated cocoa butter replacer chocolate. The specific results are shown in Table 1.

TABLE 1
Comparison between non-hydrogenated cocoa butter replacer
chocolate and hydrogenated cocoa butter replacer chocolate

| | trans fatty | | | |
|---|---|---|---|---|
| | acid content | operability | hardness | Flavor/taste |
| non-hydrogenated | 0 | good | moderate | soft, pure |
| chocolate | | | | |
| hydrogenated | 0.1-0.3 | good | hard texture | soft |
| chocolate | | | | |

### EXAMPLE 2

The recipe for producing 100 kg of non-hydrogenated cocoa butter replacer chocolate is as follows: non-hydrogenated refined palm kernel oil: 25 kg; non-hydrogenated coconut oil: 12 kg; white sugar: 35 kg; cocoa powder: 7 kg; skim milk powder: 8 kg; whey powder: 4 kg; maltodextrin: 3.5 kg; soybean protein powder: 2 kg; glyceryl monostearate: 2.5 kg; soy phospholipid: 0.5 kg; polyglycerol polyricinoleate: 0.2 kg; sucrose fatty acid ester: 0.2 kg; and food flavor vanillin: 0.1 kg.

Preparation Process:

1) pulverizing the white sugar, using a powder sugar machine, into a sugar powder.

2) putting the non-hydrogenated vegetable oil, the sucrose fatty acid ester, and the glyceryl monostearate into a melting pot to melt to obtain an oil phase, which is kept at 70-90° C. for use.

3) mixing the sugar powder, the cocoa powder, the milk powder, the soy protein powder, the maltodextrin, and a portion of the oil phase, and transferring the mixture to a two-roll mill and a five-roll mill to grind to 15-30 microns. Then, transporting the milled mixture to a mixing tank with shear agitation function, and adding the remaining oil phase, shearing, and stirring until a uniform chocolate slurry is formed. Finally, adding the soybean phospholipid, the polyglycerol polyricinoleate, and the food flavor.

4) transporting the finely milled material to an insulation tank for chocolate, and then pouring with a pouring machine or manually pouring into a cooling channel for cooling at 3-10° C. After cooling, performing packaging, inspection, and storage.

Finished warehouse temperature should be maintained at 18-25° C. and relative humidity≤60%.

The chocolate obtained by the above method has been tested. Its trans-fatty acid content is 0, its texture is no longer soft, and its operability is good, without vegetable oil taste and having good taste and mouthfeel. This product is compared with the hydrogenated cocoa butter replacer chocolate. The specific results are shown in Table 2.

TABLE 2
Comparison between non-hydrogenated cocoa butter replacer
chocolate and hydrogenated cocoa butter replacer chocolate

| | trans fatty | | | |
|---|---|---|---|---|
| | acid content | operability | hardness | Flavor/taste |
| non-hydrogenated | 0 | good | moderate | soft, pure |
| chocolate | | | | |
| hydrogenated | 0.1-0.3 | good | hard texture | soft |
| chocolate | | | | |

### EXAMPLE 3

The recipe for producing 100 kg of non-hydrogenated cocoa butter replacer chocolate is as follows: non-hydrogenated refined palm kernel oil: 28 kg; non-hydrogenated coconut oil: 12 kg; white sugar: 30 kg; cocoa powder: 9 kg; skim milk powder: 7 kg; whey powder: 3 kg; maltodextrin: 5 kg; soybean protein powder: 2.6 kg; glyceryl monostearate: 2.5 kg; soy phospholipid: 0.45 kg; polyglycerol polyricinoleate: 0.2 kg; sucrose fatty acid ester: 0.2 kg; and food flavor vanillin: 0.05 kg.

Preparation Process:

1) pulverizing the white sugar, using a powder sugar machine, into a sugar powder.

2) putting the non-hydrogenated vegetable oil, the sucrose fatty acid ester, and the glyceryl monostearate into a melting pot to melt to obtain an oil phase, which is kept at 70-90° C. for use.

3) mixing the sugar powder, the cocoa powder, the milk powder, the soy protein powder, the maltodextrin, and a portion of the oil phase. Transferring the mixture to a two-roll mill and a five-roll mill to grind to 15-30 microns, and then transporting the milled mixture to a mixing tank with shear agitation function. Adding remaining fats, shearing, and stirring until a uniform chocolate slurry is formed. Finally adding the soybean phospholipid, the polyglycerol ricinoleiceate, and the food flavor.

4) transporting the finely milled material to an insulation tank for chocolate, and then pouring with a pouring machine or manually pouring into a cooling channel for cooling at 3-10° C. After cooling, performing packaging, inspection, and storage.

Finished warehouse temperature should be maintained at 18-25° C. and relative humidity≤60%.

The chocolate obtained by the above method has been tested. Its trans-fatty acid content is 0, and its texture is no longer soft, and its operability is good, without vegetable oil taste and having good taste and mouthfeel. This product is compared with a hydrogenated cocoa butter replacer chocolate. The specific results are shown in Table 3.

TABLE 3
Comparison between non-hydrogenated cocoa butter replacer
chocolate and hydrogenated cocoa butter replacer chocolate

| | trans fatty | | | |
|---|---|---|---|---|
| | acid content | operability | hardness | Flavor/taste |
| non-hydrogenated | 0 | good | moderate | soft, pure |
| chocolate | | | | |
| hydrogenated | 0.1-0.3 | good | hard texture | soft |
| chocolate | | | | |

### COMPARATIVE EXAMPLES

The comparative examples mainly examine the effects of the synergistic use of emulsifiers on the properties of chocolate products, such as stability, handling, and hardness.

### COMPARATIVE EXAMPLE 1

Recipe: non-hydrogenated refined palm kernel oil: 28 kg; non-hydrogenated coconut oil: 12 kg; white sugar: 30 kg; cocoa powder: 9 kg; skim milk powder: 7 kg; whey powder: 3 kg; maltodextrin: 5 kg; soybean protein powder: 2.6 kg; glyceryl monostearate: 0 kg; soy phospholipid: 0.45 kg; polyglycerol polyricinoleate: 0.2 kg; sucrose fatty acid ester: 0.2 kg; and food flavor vanillin: 0.05 kg.

Preparation process is similar to that of Example 1.

### COMPARATIVE EXAMPLE 2

Recipe: non-hydrogenated refined palm kernel oil: 28 kg; non-hydrogenated coconut oil: 12 kg; white sugar: 30 kg; cocoa powder: 9 kg; skim milk powder: 7 kg; whey powder: 3 kg; maltodextrin: 5 kg; soybean protein powder: 2.6 kg; glyceryl monostearate: 2.5 kg; soy phospholipid: 0.45 kg; polyglycerol polyricinoleate: 0.2 kg; sucrose fatty acid ester: 0 kg; and food flavor vanillin: 0.05 kg.

Preparation process is similar to that of Example 1.

The stability, operability and hardness of the chocolate products obtained from the above three comparative examples were compared respectively, and the specific results are shown in Table 4.

TABLE 4
Comparison results of performance of chocolate products
made from Example 3 and Comparative Examples 1 and 2

| | Property | | | |
|---|---|---|---|---|
| test sample | operability | hardness | stability | taste |
| Example 3 | chocolate | moderate, | delicate tissue, | smooth and |
| | is plastic | neither | no separation | delicate |
| | and easy to | soft nor | for a long time, | |
| | handle | hard | no cracking | |
| | | | after freezing | |
| Comparative | poor | soft | tough tissue, | melting |
| Example 1 | plasticity, | texture | separation for | and rough |
| | not easy to | | a long time, | feeling |
| | operate | | cracking after | |
| | | | freezing | |
| Comparative | poor | soft | tough tissue, | melting |
| Example 2 | plasticity, | texture | separation for | and rough |
| | not easy to | | a long time, | feeling |
| | operate | | cracking after | |
| | | | freezing | |

What is claimed is:

1. A chocolate made from non-hydrogenated cocoa butter replacer, characterized in that the chocolate consists of following percentages by weight of raw materials:
non-hydrogenated vegetable oil: 35-50%;
white sugar: 30-50%;
cocoa powder: 6-30%;
milk powder: 5%-40%;
maltodextrin: 1-10%;
soybean protein: 2-8%;
glyceryl monostearate: 1-5%;
soybean phospholipid: 0.2-0.5%;
polyglycerol polyricinoleate: 0.1-0.3%;
sucrose fatty acid ester: 0.1-0.3%; and
food flavor: 0.01-0.1%.

2. The chocolate made from non-hydrogenated cocoa butter replacer according to claim 1, characterized in that the non-hydrogenated vegetable oil is a mixture of refined palm kernel oil and coconut oil.

3. The chocolate made from non-hydrogenated cocoa butter replacer according to claim 2, characterized in that the refined palm kernel oil and coconut oil have a weight ratio of 25-28:10-12.

4. The chocolate made from non-hydrogenated cocoa butter replacer according to claim 1, characterized in that the milk powder is a skimmed milk powder or a whey powder.

5. A method for preparing the non-hydrogenated cocoa butter replacer chocolate of claim 1, comprising the steps of:
1) pulverizing the white sugar, using a powder sugar machine, into a sugar powder;
2) putting the non-hydrogenated vegetable oil, the sucrose fatty acid ester, and the glyceryl monostearate into a melting pot to melt to obtain an oil phase, which is kept at 70-90° C. for use;
3) mixing the sugar powder, the cocoa powder, the milk powder, the soy protein powder, the maltodextrin, and a portion of the oil phase; transferring resulting mixture to a two-roll mill and a five-roll mill to grind to 15-30 microns; transporting resulting milled mixture to a mixing tank with shear agitation function; adding the remaining of the oil phase; shearing, and stirring until a uniform chocolate slurry is formed, followed by adding the soybean phospholipid, the polyglycerol ricinoleiceate, and the food flavor; and
4) transporting the finely milled material to an insulation tank for chocolate, and then pouring, using a pouring machine, or manually pouring into a cooling channel for cooling at 3-10° C.; after cooling, performing packaging, inspection, and storage.

6. The preparation method according to claim 5, characterized in that in step 3), during the milling process, the mixture is subjected to three successive stages of tightening grids with a milling time of 8-10 hours and a heating temperature of 50-75° C. until the chocolate slurry is finely milled to 15-30 microns, followed by loosening the grids; and then adding the soybean phospholipid, the polyglycerol polyricinoleate, and the food flavor, followed by mixing for half an hour before delivery to the chocolate insulation tank and filling.
